(19) United States
(12) Patent Application Publication
(10) Pub. No.: US 2009/0096794 A1
(43) Pub. Date: Apr. 16, 2009

(54) THICK LINE DRAWING METHOD AND APPARATUS THEREOF

(76) Inventors: Tsung-Hsun Yang, Hsinchu County (TW); Shu-Wen Teng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/873,397

(22) Filed: Oct. 16, 2007

(51) Int. Cl. G06T 11/20

(52) U.S. Cl. 345/443

(57) ABSTRACT

A thick line drawing method includes: drawing at least a predetermined pattern according to a thickness of a thick line to be drawn and at least one of a start point and an end point of a line path corresponding to the thick line; determining a plurality of polygon vertexes according to the predetermined pattern; and performing a polygon filling operation to fill a polygon region defined by the polygon vertexes, and storing a drawing result of filling the polygon region into a frame buffer.

### BACKGROUND

The present invention relates to drawing thick lines, and more particularly, to a thick line drawing method that utilizes circle drawing and regular polygon drawing to draw thick lines and related apparatus thereof.

Regarding graphics processing, drawing thick lines is commonly required for many cases. If the graphics processing hardware is equipped with sufficient computing power, the thick lines can be drawn and shown on a display screen with high quality. However, if the graphics processing hardware is designed to have limited computing power due to cost constrains, adopting the complicated thick line drawing algorithm is inadequate.

Taking a navigation system for example, it requires graphics processing to show an electronic map or routes on a display screen. Therefore, thick lines, each having thickness greater than one, are often drawn and displayed on the display screen. Provided that the navigation system does not have sufficient computing power due to cost constrains, the navigation system requires a simplified drawing algorithm to present the desired thick lines to the user. If a conventional single line drawing method is implemented to construct a thick line by repeatedly drawing a single line, the drawing speed of the thick line can be accelerated accordingly. However, the acceleration of the thick line drawing speed is achieved at the expense of thick line quality. For instance, the conventional single line drawing method can not guarantee to produce a smooth joint of two thick lines having any included angle; additionally, if thick lines of the same thickness but having different slopes are required to be drawn and shown on the display screen, the actual thick lines produced by the conventional single line drawing method will have different thickness perceived by the user. Therefore, to avoid those problems caused by using the conventional single line drawing method, a novel and simple thick line drawing scheme is required for the graphics processing hardware not equipped with high computing power.

### SUMMARY

According to one embodiment of the present invention, a thick line drawing method is provided. The thick line method includes: drawing at least a predetermined pattern according to a thickness of a thick line to be drawn and at least one of a start point and an end point of a line path corresponding to the thick line; determining a plurality of polygon vertexes according to the predetermined pattern; and performing a polygon filling operation to fill a polygon region defined by the polygon vertexes, and storing a drawing result of filling the polygon region into a frame buffer.

According to another embodiment of the present invention, a thick line drawing apparatus is provided. The thick line drawing apparatus includes: a frame buffer; a pattern drawing engine, for drawing at least a predetermined pattern according to a thickness of a thick line to be drawn and at least one of a start point and an end point of a line path corresponding to the thick line; and a polygon filling engine, coupled to the pattern drawing engine and the frame buffer, for determining a plurality of polygon vertexes according to the predetermined pattern, performing a polygon filling operation to fill a polygon region defined by the polygon vertexes, and storing a drawing result of the polygon region into the frame buffer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a thick line drawing apparatus according to a first exemplary embodiment of the present invention.

FIG. 2 is a flowchart illustrating a thick line drawing method according to an embodiment of the present invention.

FIG. 3 is a detailed flowchart of step 204 shown in FIG. 2.

FIG. 4 is a diagram illustrating a plurality of points disposed at a line path of a target dotted thick line.

FIG. 5 is a detailed flowchart of step 205 shown in FIG. 2.

FIG. 6 is a diagram illustrating quantized normal vectors corresponding to circles with different radii.

FIG. 7 is a detailed flowchart of step 206 shown in FIG. 1.

FIG. 8 is a diagram illustrating an example of locating a plurality of polygon vertexes when the thick line thickness is equal to an odd number.

FIG. 9 is a diagram illustrating an example of locating a plurality of polygon vertexes when the thick line thickness is equal to an even number.

FIG. 10 is a block diagram illustrating a thick line drawing apparatus according to a second exemplary embodiment of the present invention.

FIG. 11 is a diagram illustrating thick lines drawn by the disclosed drawing method and conventional drawing method.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

The present invention provides a thick line drawing scheme which uses a pattern drawing engine to draw a predetermined pattern (e.g., a circle or regular polygon) as a reference to locate a plurality of polygon vertexes and then performs a polygon filling operation to fill a polygon region defined by the polygon vertexes to drawn the thick line. Further description is given as below.

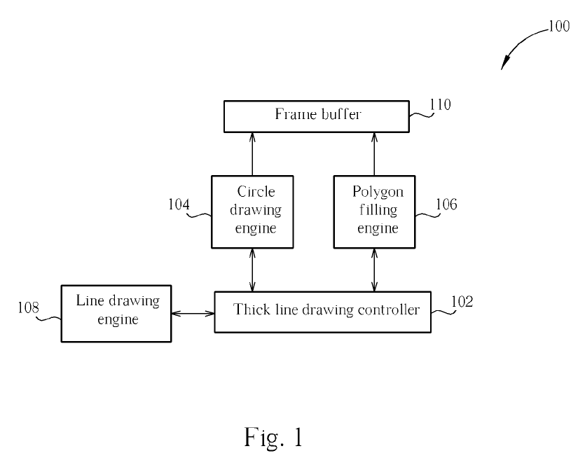

Please refer to FIG. 1. FIG. 1 is a block diagram illustrating a thick line drawing apparatus 100 according to a first exemplary embodiment of the present invention. In this embodiment, the thick line drawing apparatus 100 includes a thick line drawing controller 102, a pattern drawing engine (i.e., a circle drawing engine 104 in this embodiment), a polygon filling engine 106, a line drawing engine 108, and a frame buffer 110. The circle drawing engine 104 is configured to draw a circle if information of a center point and a radius is given, and selectively fill the circle when needed. The polygon filling engine 106 is configured to find a plurality of polygon vertexes corresponding to a thick line to be drawn, fill a polygon region defined by the polygon vertexes, and then store the drawing result into the frame buffer. The thick line drawing controller 102 is configured to control the thick line drawing operation. For example, the thick line drawing controller 102 output parameters, such as coordinate information of the circle center and the length information of the circle radius, to the circle drawing engine 104 and then instruct the circle drawing engine 104 to perform the circle drawing operation and selectively store a drawing result into the frame buffer 110 according to drawing requirements of the thick line. As known to those skilled in this art, the frame buffer 110 is used to buffer pixel data to be displayed on the display screen. In other words, if the drawing result is not stored into the frame buffer 110, it will not be displayed on the display screen. In this embodiment, the line drawing engine 108 is implemented to support dotted thick line drawing. Therefore, when the dotted thick line drawing is requested, the thick line drawing controller 102 will actuate the line drawing engine 108 to locate two ends of each line segment along a line path of a desired dotted thick line. Next, the coordinate information of a start point and an end point of the line segment is delivered to the circle drawing engine 104 through the thick line drawing controller 102. Further description is given later.

Please note that only the components pertinent to the present invention are shown in FIG. 1, and the configuration in FIG. 1 is for illustrative purposes. That is, provided that the result is substantially the same, other configurations not departing from the spirit of the present invention are possible. Moreover, any of the thick line drawing controller 102, the circle drawing engine 104, the polygon filling engine 106, and the line drawing engine 108 can be implemented by hardware, software, or a combination thereof.

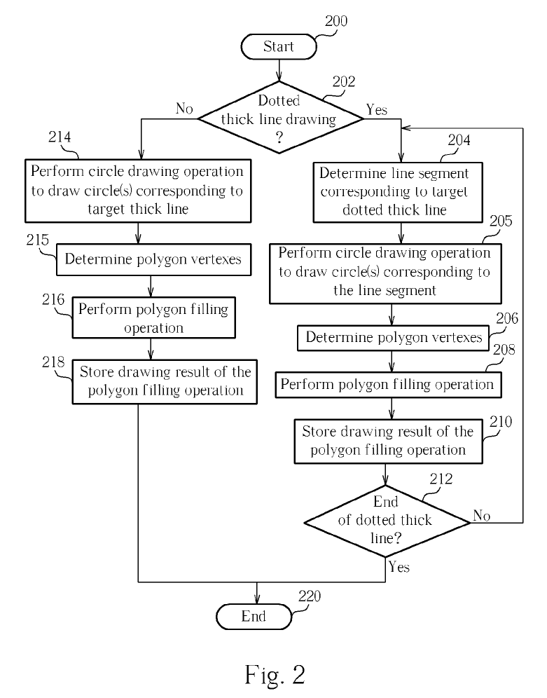

Please refer to FIG. 2 in conjunction with FIG. 1. FIG. 2 is a flowchart illustrating a thick line drawing method according to an embodiment of the present invention. Provided the result is substantially the same, the steps shown in FIG. 2 are not limited to be executed in the exact order. The exemplary thick line drawing method includes following steps:
Step 200: Start.
Step 202: Check if the dotted thick line drawing is needed for drawing a target dotted thick line. If yes, go to step 204; otherwise, go to step 214.
Step 204: Determine a line segment along a line path corresponding to the target dotted thick line.
Step 205: Perform a circle drawing operation to draw one or more circles corresponding to the line segment.
Step 206: Determine a plurality of polygon vertexes according to a drawing result of the circle drawing operation.
Step 208: Perform a polygon filling operation to fill a polygon region defined by the polygon vertexes to draw a thick line corresponding to the line segment.
Step 210: Store a drawing result of the polygon filling operation in step 208 into a frame buffer.
Step 212: Check if an end of the target dotted thick line is reached. If yes, go to step 220; otherwise, go to step 204 to determine a next line segment.
Step 214: Perform a circle drawing operation to draw one or more circles corresponding to a target thick line.
Step 215: Determine a plurality of polygon vertexes according to a drawing result of the circle drawing operation.
Step 216: Perform a polygon filling operation to fill a polygon region defined by the polygon vertexes to draw the target thick line.
Step 218: Store a drawing result of the polygon filling operation in step 216 into a frame buffer.
Step 220: End.

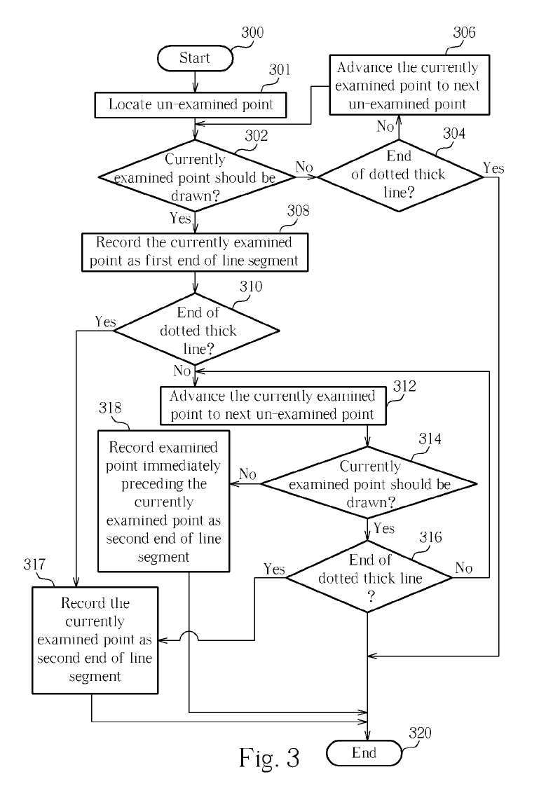

In step 200, the flow of thick line drawing begins. The exemplary thick line drawing method disclosed in the present invention supports drawing of a dotted thick line consisted of a plurality of thick lines. Therefore, if there is a need for drawing a target dotted thick line (step 202), the thick line drawing controller 102 will activate the line drawing engine 108 to locate each line segment along the line path of the target dotted thick line (step 204). Please refer to FIG. 3, which is a detailed flowchart of step 204 shown in FIG. 2. The line segment determination procedure includes following steps:
Step 300: Start.
Step 301: Locate an un-examined point at the line path of the target dotted thick line to start the line segment determination procedure. For example, a start point or an end point of the line path is selected if it is the first round of the line segment determination procedure; otherwise, an un-examined point immediately following an examined point is selected for subsequent round(s) of the line segment determination procedure.
Step 302: Is a currently examined point at the line path of the target dotted thick line a point to be drawn? If yes, go to step 308; otherwise, go to step 304.
Step 304: Check if an end of the dotted thick line is reached. If yes, go to step 320; otherwise, go to step 306.
Step 306: Advance the currently examined point to a next un-examined point, and then go to step 302.
Step 308: Record the currently examined point as a first end (e.g., a start point) of a line segment along the line path of the target dotted thick line.
Step 310: Check if an end of the dotted thick line is reached. If yes, go to step 317; otherwise, go to step 312.
Step 312: Advance the currently examined point to a next un-examined point.
Step 314: Is the currently examined point a point to be drawn? If yes, go to step 316; otherwise, go to step 318.
Step 316: Check if an end of the dotted thick line is reached. If yes, go to step 317; otherwise, go to step 312.
Step 317: Record the currently examined point as a second end (e.g., an end point) of the line segment along the line path of the target dotted thick line. Go to step 320.
Step 318: Record an examined point immediately preceding the currently examined point as a second end (e.g., an end point) of the line segment along the line path of the target dotted thick line.
Step 320: End.

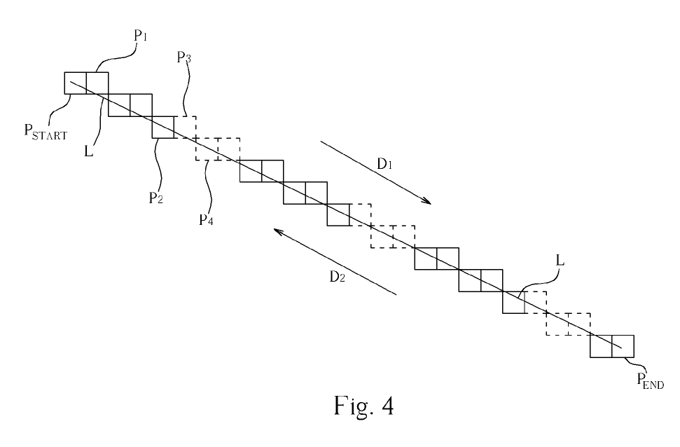

The line segment determination procedure is performed by the line drawing engine 108 according to a point-by-point fashion, i.e., a pixel-by-pixel fashion. In step 300, the line segment determination procedure begins. If it is the first round of identifying a line segment along a line path of a target dotted thick line, either of the start point and end point of the line path can be selected to serve as the current point to be examined (step 301). Please refer to FIG. 4 in conjunction with FIG. 3. FIG. 4 is a diagram illustrating a plurality of points disposed at a line path of a target dotted thick line. In FIG. 4, the points to be drawn due to belonging to line segments of the target dotted line are indicated by solid lines, while the other points not to be drawn are indicated by broken lines. As one can see, either the start point P_{START} or the end point P_{END} is an un-examined point initially. Therefore, regarding the first round of the line segment determination procedure, if the start point P_{START} is selected as an initial point to be examined, following points at the line path L are examined one by one according to the direction D₁; similarly, if the end point P_{END} is selected as an initial point to be examined, following points at the line path L are examined one by one according to the direction D₂ opposite to the direction D₁. Provided the start point P_{START} is selected in step 301, step 302 is performed to check if the start point P_{START} is a point to be drawn. That is, step 302 checks if the start point P_{START} belongs to a line segment corresponding to one thick line segment of the target dotted thick line. In this embodiment, as the start point P_{START} belongs to a thick line segment to be drawn, it is recorded as a first end (e.g., a start point) of a line segment (step 308). The flow proceeds to step 310. If the currently examined point is the end point of the line path, the currently examined point is also recorded as an end point of the identified line segment, and then the line segment determination procedure is completed (steps 317 and 320).

In this embodiment, as the start point P_{START} is not the end point of the line path, the following step 312 is executed. Due to the point-by-point searching scheme, the next point P₁, which is an un-examined point and is not the end point P_{END}, is selected and examined (step 312). Because the currently examined point P₁ still belongs to the line segment to be drawn, the flow proceeds to checking following un-examined points. When the currently examined point is advanced to the point P₃, step 314 finds that it is not a point to be drawn. Therefore, the line segment determination procedure identifies the previously examined point P₂ immediately preceding the currently examined point P₃ as a second end (e.g., an end point) of the line segment according to step 318. As the start point and end point of one line segment along the line path L of the target dotted thick line are both obtained, the steps 205-210 shown in FIG. 2 are executed to draw a thick line corresponding to the line segment defined by the recognized start point and end point (i.e., points P_{START} and P₂).

Since an end of the target dotted thick line is not reached yet (step 212), the thick line drawing operation continues to process any thick lines corresponding to following line segments found in step 204. Referring to the flow shown in FIG. 3 and the diagram shown in FIG. 4 again, step 301 will selects the un-examined point P₃ as an initial point for a second round of the line segment determination procedure. Following above-mentioned flow related to identifying a line segment, the start point and end point of another line segment can be identified accordingly. Since a skilled person can readily appreciate the operation of the steps in the flowchart of FIG. 3, description of other obvious operational cases supported by the disclosed line segment determination procedure is omitted here for brevity. Additionally, the flowchart shown in FIG. 3 is for illustrative purposes only. Provided the result is substantially the same, the steps shown in FIG. 3 are not limited to be executed in the exact order.

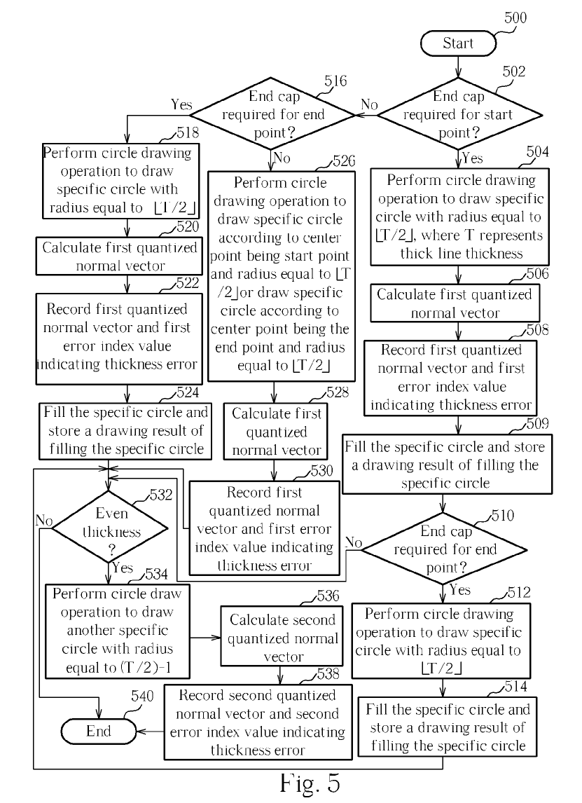

After the line drawing engine 108 determines a start point and an end point of one line segment at the line path of the target dotted thick line, the circle drawing engine 104 is informed by the thick line drawing controller 102 to start performing a circle drawing operation based on the coordinate information of the start point and end point of the line segment identified by the thick line drawing controller 102. Please refer to FIG. 5, which is a detailed flowchart of step 205 shown in FIG. 2. Provided the result is substantially the same, the steps shown in FIG. 5 are not limited to be executed in the exact order. The circle drawing procedure includes following steps:
Step 500: Start.
Step 502: Is an end cap required for one thick line end corresponding to a start point at a line path of a thick line to be drawn? If yes, go to step 504; otherwise, go to step 516.
Step 504: Perform a circle drawing operation to draw a specific circle according to the start point serving as a center point and a radius equal to └T/2┘ where └•┘ represents a floor operation, and T represents a thickness of the thick line.
Step 506: Calculate a first quantized normal vector corresponding to the center point and a reference vector defined by the start point and an end point at the line path of the thick line. The first quantized normal vector is between the center point and a point located at a circumference of the specific circle. If a first ideal normal vector can be found between the center point and a point at a circumference of the specific circle, the first quantized normal vector matches the first ideal normal vector; otherwise, there is an included angle between the first quantized normal vector and the first ideal normal vector due to quantization errors.
Step 508: Record the first quantized normal vector and a first error index value indicating a thickness error caused by the first quantized normal vector.
Step 509: Fill the specific circle and store a drawing result of filling the specific circle into a frame buffer.
Step 510: Is an end cap required for the other thick line end corresponding to the end point? If yes, go to step 512; otherwise, go to step 532.
Step 512: Perform a circle drawing operation to draw a specific circle according to the end point serving as a center point and a radius equal to └T/2┘.
Step 514: Fill the specific circle and store a drawing result of filling the specific circle into the frame buffer. Go to step 532.
Step 516: Is an end cap required for the other thick line end corresponding to the end point at the line path of the thick line to be drawn? If yes, go to step 518; otherwise, go to step 526.
Step 518: Perform a circle drawing operation to draw a specific circle according to the end point serving as a center point and a radius equal to └T/2┘.
Step 520: Calculate a first quantized normal vector corresponding to the center point and a reference vector defined by the start point and the end point. The first quantized normal vector is between the center point and a point located at a circumference of the specific circle. If a first ideal normal vector can be found between the center point and a point at a circumference of the specific circle, the first quantized normal vector matches the first ideal normal vector; otherwise, there is an included angle between the first quantized normal vector and the first ideal normal vector due to quantization errors.
Step 522: Record the first quantized normal vector and a first error index value indicating a thickness error caused by the first quantized normal vector.
Step 524: Fill the specific circle and store a drawing result of filling the specific circle into the frame buffer. Go to step 532.
Step 526: Perform a circle drawing operation to draw a specific circle according to the start point serving as a center point and a radius equal to └T/2┘ or draw a specific circle according to the end point serving as a center point and a radius equal to └T/2┘.
Step 528: Calculate a first quantized normal vector corresponding to the center point and a reference vector defined by the start point and the end point. The first quantized normal vector is between the center point and a point located at a circumference of the specific circle. If a first ideal normal vector can be found between the center point and a point at a circumference of the specific circle, the first quantized normal vector matches the first ideal normal vector; otherwise, there is an included angle between the first quantized normal vector and the first ideal normal vector due to quantization errors.
Step 530: Record the first quantized normal vector and a first error index value indicating a thickness error caused by the first quantized normal vector.
Step 532: Does the thick line to be drawn have an even thickness? If yes, go to step 534; otherwise, go to step 540.
Step 534: Perform a circle draw operation to draw another specific circle according to one of the start point and the end point serving as a center point and a radius equal to [(T/2)−1].
Step 536: Calculate a second quantized normal vector corresponding to the center point and the reference vector defined by the start point and the end point. The second quantized normal vector is between the center point and a point located at a circumference of said another specific circle. If a second ideal normal vector, different from any first ideal normal vector mentioned above, can be found between the center point and a point at a circumference of said another specific circle, the second quantized normal vector matches the second ideal normal vector; otherwise, there is an included angle between the second quantized normal vector and the second ideal normal vector due to quantization errors.
Step 538: Record the second quantized normal vector and a second error index value indicating a thickness error caused by the second quantized normal vector.
Step 540: End.

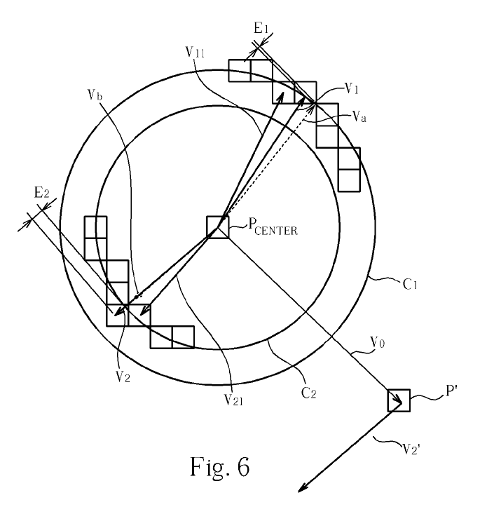

The operation of steps 504-509 is similar to that of steps 518-524, and the only difference is that the center points used in steps 504 and 518 differ from each other. In an exemplary embodiment of the present invention, a pixel-based thick line drawing scheme is implemented, and the circle drawing procedure requires a radius having an integer value to draw a circle. Therefore, in steps 504 and 518, a floor value of a half of the thick line thickness is used to define the radius required for circle drawing. In steps 506 and 520, a first quantized normal vector is estimated. Please refer to FIG. 6. FIG. 6 is a diagram illustrating quantized normal vectors corresponding to circles with different radii. The center point P_{CENTER} could be a start point correspond to a thick line to be drawn (step 504) or an end point corresponding to a thick line to be drawn (step 518). Please note that, as to the dotted thick line drawing, the center point P_{CENTER} could be a start point or an end point of a line segment identified in step 204 by the line drawing engine 108. However, as to the normal thick line drawing (steps 518-528), the above-mentioned start point and end point are not required to be determined by the line drawing engine 108.

In FIG. 6, the radius of the circle C₁ is equal to └T/2┘. Because the circumference of the circle C₁ is consisted of fixed-size points (i.e., pixels), there might be quantization errors when determining the normal vector of a reference vector V₀ defined by the start point (e.g., P_{CENTER}) and the end point (e.g., P′) of the thick line to be drawn. As one can see, no point/pixel, pointed to by a first ideal normal vector Vₐ, is included in the circumference of the circle C₁. Therefore, a vector closest to the first ideal normal vector V₁ is selected as the first quantized normal vector V₁ (steps 506 and 520). Due to quantization error, a thickness error E₁ is present between the first ideal normal vector Vₐ and the first quantized normal vector V₁. In addition to recording the first quantized normal vector V₁, the circle drawing engine 104 further records a first error index value representative of the thickness error E₁ (steps 508 and 522). Additionally, if an end cap is required to be shown at one end of the thick line under certain cases, the circle drawing engine 104 also supports this feature by filling the circle drawn in steps 504 and 518 and then storing the corresponding drawing result into the frame buffer 110 (steps 509 and 524). As a result, there is no sharp edge(s) presented at end(s) of the thick line when the thick line is displayed on a display screen according to pixel data stored in the frame buffer 110.

Regarding a case where both ends of the thick line require end caps, if the first quantized normal vector V₁ has been obtained after a circle corresponding to the center point P_{CENTER} is drawn, filled, and stored, there is no need to find another quantized normal vector after another circle corresponding to the point P′ is drawn. The reason is self-explanatory after reading following paragraphs, and detailed description is skipped here.

Regarding a case where both ends of the thick line don't require caps, the circle drawing engine 104 only has to draw one circle having the center point P_{CENTER} being either the start point or the end point corresponding to the thick line to be drawn (step 526), and then calculate and store the first quantized normal vector V₁ (steps 528 and 530). Similarly, a thickness error between the first quantized normal vector V₁ and the first ideal normal vector Vₐ is estimated and stored into the frame buffer 110 through the circle drawing engine 106 (step 530). As there is no need to add end caps to respective ends of the thick line, the above-mentioned operations of filling the circle and storing the corresponding drawing result into the frame buffer are omitted.

When the thickness of the thick line is an odd number, the circle drawing procedure is completed after obtaining the first quantized normal vector and first error index value used in the following step of determining polygon vertexes, i.e., step 206 shown in FIG. 2. However, when the thickness of the thick line is an even number, the flow in FIG. 5 proceeds to steps 534-538. As mentioned above, the circle drawing engine 104 uses a circle drawing algorithm requiring the radius to be an integer value. Additionally, the center point P_{CENTER} has a fixed size. Therefore, provided that the thickness of the thick line is equal to four (T=4), the circle drawing operation then requires a radius equal to 1.5 for drawing a circle according to the center point P_{CENTER}. This violates the specification of the circle drawing engine 104. Therefore, another circle C₂ is drawn to solve this problem, where the radius is set by [(T/2)−1] according to step 534. As one can see in FIG. 6, along the direction of a second ideal normal vector V_{b}, a point located at the circumference of the circle C₂ does exist. Therefore, a vector between the center point P_{CENTER} and the above-mentioned point is selected as a second quantized normal vector V₂. However, in a case where no point, pointed to by the second ideal normal vector V_{b}, is included in the circumference of the circle C₂, the aforementioned means of determining the first quantized normal vector V₁ is applied to locate the second quantized normal vector V₂. Due to quantization errors, a thickness error E₂ is present between the second ideal normal vector V_{b} and the second quantized normal vector V₂. In addition to recording the second quantized normal vector V₂, the circle drawing engine 104 further records a second error index value representative of the thickness error E₂ (step 538). To better explain above operations, an example is given here. Suppose that the thickness of the thick line is equal to four (T=4), the radius of the circle C₁ is set by 2, and the radius of the circle C₂ is set by 1. Therefore, the sum of a length of the first ideal normal vector Vₐ and a length of the second ideal normal vector V_{b} is equal to 4. In this way, referring to the diagram shown in FIG. 6, a distance between points respectively pointed to by the first and second quantized normal vectors V₁ and V₂ approximates to the ideal thickness of the thick line to be drawn.

It should be noted that directions of vectors shown in FIG. 6 are for illustrative purposes only, and not meant to be limitations of the present invention. Moreover, the circles C₁ and C₂ are not limited to have a common center point P_{CENTER} as shown in FIG. 6. In an alternative design, the circle drawing engine 104 can take the point P′ as a center point to draw the auxiliary circle C₂ to obtain a second quantized normal vector V₂′ and the same thickness error E₂ because of the geometry characteristics. Since the geometry characteristics can be readily appreciated by a person skilled in this art according to the diagram depicted in FIG. 6, further description is omitted here for brevity. Moreover, referring to the flowchart shown in FIG. 5, the processing of the circle corresponding to the start point (steps 504-509) is performed prior to processing the circle corresponding to the end point (steps 512 and 514). However, reversing the processing order is possible with adequate modifications. This still obeys the spirit of the present invention.

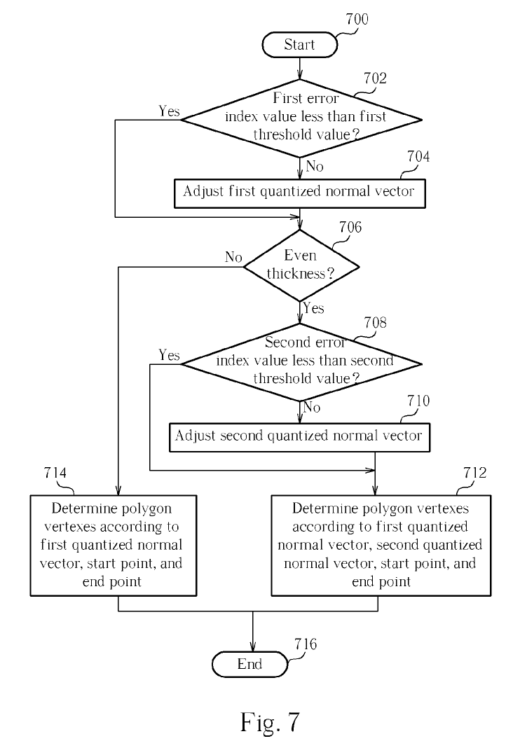

After the first quantized normal vector and first error index value are obtained if the thick line has an odd thickness or the first and second quantized normal vectors and first and second error index values are obtained if the thick line has an even thickness, the thick line drawing controller 102 instructs the polygon filling engine 106 to take over following data processing. Please refer to FIG. 7. FIG. 7 is a detailed flowchart of step 206 shown in FIG. 1. Provided the result is substantially the same, the steps shown in FIG. 7 are not limited to be executed in the exact order. The polygon vertex determination procedure includes following steps:
Step 700: Start.
Step 702: Check if a first error index value is less than a first threshold value. If yes, go to step 706; otherwise, go to step 704.
Step 704: Adjust a first quantized normal vector to thereby reduce the thickness error.
Step 706: Does a thick line to be drawn have an even thickness? If yes, go to step 708; otherwise, go to step 714.
Step 708: Check if a second error index value is less than a second threshold value. If yes, go to step 712; otherwise, go to step 710.
Step 710: Adjust a second quantized normal vector to thereby reduce the thickness error.
Step 712: Determine a plurality of polygon vertexes (e.g., four polygon vertexes) according to the first quantized normal vector, the second quantized normal vector, and a start point and an end point of a line path of a thick line to be drawn. Go to step 716.
Step 714: Determine a plurality of polygon vertexes according to the first quantized normal vector, and a start point and an end point of a line path of a thick line to be drawn.
Step 716: End.

In this embodiment, steps 704 and 710 are implemented to fine tune the first quantized normal vector and the second quantized normal vector respectively, and steps 702 and 708 are implemented to determine if the compensation mechanism should be activated. According to the flow shown in FIG. 7, the polygon filling engine 106 firstly checks if the first error index value representative of the thickness error (e.g., E₁ shown in FIG. 6) is less than the first threshold value. In other words, the first threshold value defines a tolerance range, and there is no need to adjust the first quantized normal vector originally given by the circle drawing engine 104 when the thickness error indicated by the first error index value is acceptable. However, when the first error index value is not less than the first threshold value, meaning that thick line quality might be greatly degraded due to the excessive thickness error, the polygon filling engine 106 adjusts the first quantized normal vector to reduce the thickness error. For example, provided a thickness error between the vector V₁₁ in FIG. 6 and the first ideal normal vector Vₐ is smaller than E₁, the polygon filling engine 106 selects the vector V₁₁ as the first quantized normal vector. Preferably, the first quantized normal vector is fine tuned to make a thickness error between the adjusted first quantized normal vector and the first ideal normal vector Vₐ less than the first threshold value. However, this is not meant to be a limitation of the present invention. In other words, the thick line quality could be improved as long as the current thickness error is reduced by adjusting the first quantized normal vector.

Next, if the thickness of the thick line to be drawn is equal to an even number, meaning that the circle drawing engine 104 further provides the second error index value and the second quantized normal vector as mentioned above, the polygon filling engine 106 is also configured to check if the second error index value representative of the thickness error (e.g., E₂ shown in FIG. 6) is less than the second threshold value. It should be noted that the second threshold value could be set by a value equal to the first threshold value or any allowable value, depending upon design requirements. Similarly, the second threshold value is used to define a tolerance range. There is no need to adjust the second quantized normal vector originally given by the circle drawing engine 104 when the thickness error indicated by the second error index value is acceptable; otherwise, the polygon filling engine 106 adjusts the second quantized normal vector according to the aforementioned adjustment rules applied to the first quantized normal vector. For example, the polygon filling engine 106 updates the second quantized normal vector by the vector V₂₁.

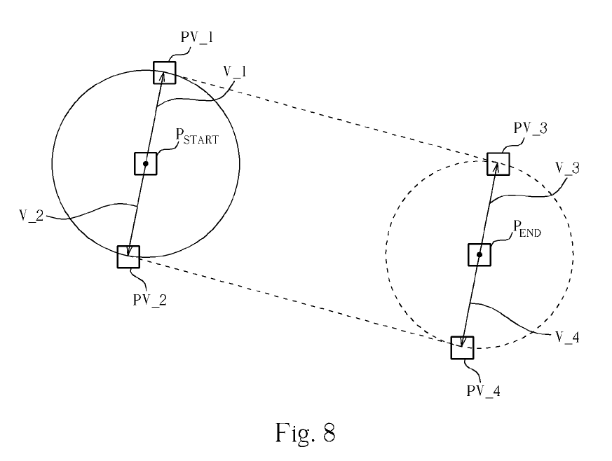

As clearly shown in FIG. 7, when the thick line thickness is equal to an odd number, determination of the polygon vertexes requires the first quantized normal vector and the start point and end point of the thick line. Please refer to FIG. 8. FIG. 8 is a diagram illustrating an example of locating a plurality of polygon vertexes when the thick line thickness is equal to an odd number. In this example, the vector V_1 represents the above-mentioned first quantized normal vector which is originally given by the cycle drawing engine 104 or has been fine-tuned by the polygon filling engine 106. Due to the geometry characteristics, other vectors V_2, V_3, and V_4 are quickly known according to the vector V_1. As one can see, the vector V_2 is opposite to the vector V_1, the vector V_3 is parallel with the vector V_1, and the vector V_4 is opposite to the vector V_3. Referring to the start point P_{START}, the end point P_{END}, and the vectors V_1, V_2, V_3, V_4, four polygon vertexes PV_1, PV_2, PV_3, and PV_4 are easily obtained.

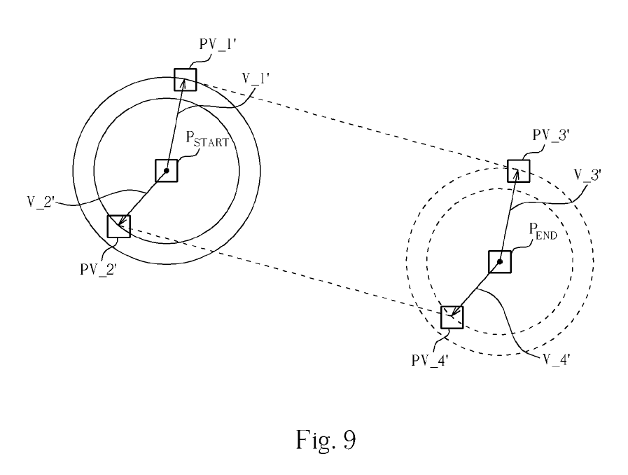

When the thick line thickness is equal to an even number, determination of the polygon vertexes requires both of the first and second quantized normal vectors and the start point and end point of the thick line. Please refer to FIG. 9. FIG. 9 is a diagram illustrating an example of locating a plurality of polygon vertexes when the thick line thickness is equal to an even number. In this example, the vector V_1′ represents the above-mentioned first quantized normal vector which is originally given by the cycle drawing engine 104 or has been fine-tuned by the polygon filling engine 106, and the vector V_2′ represents the above-mentioned second quantized normal vector which is originally given by the cycle drawing engine 104 or has been fine-tuned by the polygon filling engine 106. Due to the geometry characteristics, other vectors V_3′ and V_4′ are quickly known according to the vectors V_1′ and V_2′. As one can see, the vector V_3′ is parallel with the vector V_1′ and vector V_4′ is parallel with the vector V_2′. Referring to the start point P_{START}, the end point P_{END}, and the vectors V_1′, V_2′, V_3′, V_4′, four polygon vertexes PV_1′, PV_2′, PV_3′, and PV_4′ are easily obtained.

After the polygon vertexes are successfully determined, the polygon filling engine 106 starts performing a polygon filling operation to fill a polygon region defined by these identified polygon vertexes, such as PV_1, PV_2, PV_3, and PV_4 shown in FIG. 8 or PV_1′, PV_2′, PV_3′, and PV_4′ shown in FIG. 9, and then the polygon filling engine 106 stores the drawing result of filling the polygon region into the frame buffer 110 to complete the thick line drawing operation (steps 208 and 210).

Regarding steps 214-218 shown in FIG. 2, a skilled person can readily appreciate the corresponding operations after reading above disclosure directed to steps 205-210. Further disclosure is omitted here for brevity. In addition, regarding the dotted thick line drawing, the flow shown in FIG. 2 executes steps 206-210 each time a new line segment is identified by step 204. However, this is not meant to be a limitation of the present invention. For instance, based upon the above teachings, the line segment determination procedure can be modified to locate all of the possible line segments along the line path of the target dotted thick line, and then the dotted thick line drawing operation refers to coordinate of start points and end points of these identified line segments to execute the following polygon vertex determination procedure and polygon filling operation to draw the thick line segments in the target dotted thick line. This also obeys the spirit of the present invention.

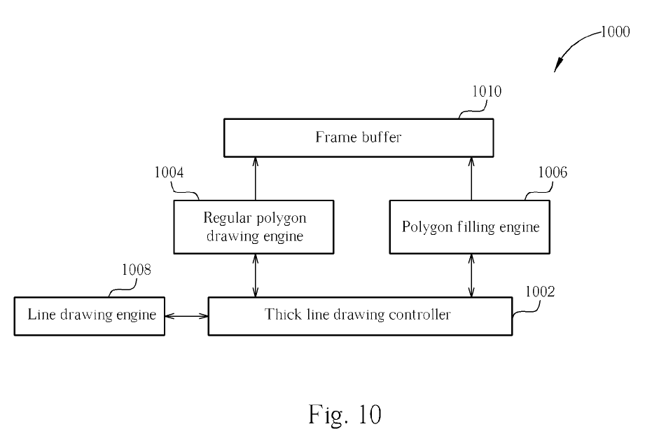

Please refer to FIG. 10. FIG. 10 is a block diagram illustrating a thick line drawing apparatus 1000 according to a second exemplary embodiment of the present invention. In this embodiment, the thick line drawing apparatus 1000 includes a thick line drawing controller 1002, a pattern drawing engine (i.e., a regular polygon drawing engine 1004 in this embodiment), a polygon filling engine 1006, a line drawing engine 1008, and a frame buffer 1010. In embodiments shown in FIG. 1 and FIG. 10, the components of the same name have identical operation and functionality. Further description therefore is omitted here. The key difference is that the thick line drawing apparatus 1000 adopts the regular polygon drawing engine 1004. As known to those skilled in this art, a circle can be approximated by an N-side regular polygon. Therefore, with slight modifications made to the flowchart shown in FIG. 5, a polygon drawing procedure performed by the regular polygon drawing engine 1004 is obtained. For example, in this embodiment, the above term “radius” could be an inradius (i.e., a distance between a center point and a midpoint of one side of a regular polygon to be drawn) or a circumradius (i.e., a distance from the center point to any vertex of the regular polygon). After a regular polygon is drawn by the regular polygon drawing engine 1004, the regular polygon drawing engine 1004 can compute the quantized normal vector and error index value needed in the following data processing according to the same means utilized by the circle drawing engine 104. For example, points (e.g., pixels) at sides of the regular polygon are checked to determine the desired quantized normal vector.

In above embodiments of the present invention, the circle drawing engine 104 and the regular polygon drawing engine 1004 are designed to use drawing algorithms requiring the radius to be an integer. However, this is not meant to be a limitation of the present invention. In alternative designs of the present invention, the circle drawing engine 104 and the regular polygon drawing engine 1004 can be configured to use other drawing algorithms not requiring the radius to be an integer. Therefore, steps 532, 534, 536, and 538 shown in FIG. 5 can be omitted accordingly. In addition, steps 704, 710 are executed to reduce or minimize the thickness error. This feature, however, is optional. That is, the thick line drawing operation without activating any thickness error compensation still falls in the scope of the present invention.

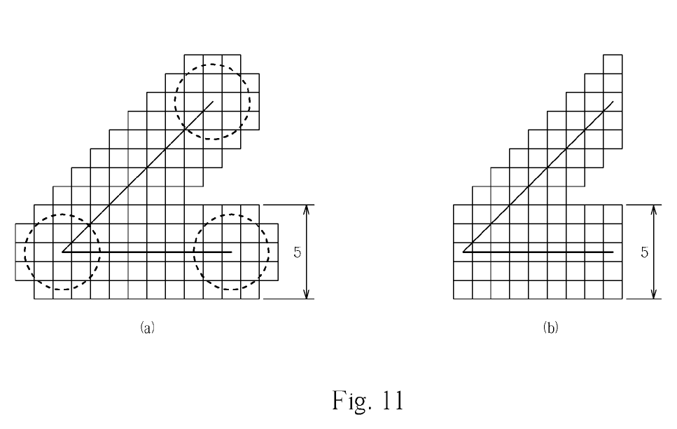

To better illustrate the difference between the conventional drawing scheme and the disclosed drawing scheme of the present invention, please refer to FIG. 11. FIG. 11 is a diagram illustrating thick lines drawn by the disclosed drawing method and conventional drawing method. In a sub-diagram (a) of FIG. 11, two thick lines each with thickness equal to five are drawn according to the exemplary drawing method disclosed above. In a sub-diagram (b) of FIG. 11, two thick lines each with thickness equal to five are drawn by repeating a single line according to the conventional method. Compared to the conventional method, the disclosed exemplary drawing method provides an easy way to draw the thick lines with improved quality. In short, problems caused by using the convention method are avoided when the thick line drawing method of the present invention is used.

Those skilled in the art will readily observe that numerous modifications and alterations of the device and method may be made while retaining the teachings of the invention.

What is claimed is:

1. A thick line drawing method, comprising:
drawing at least a predetermined pattern according to a thickness of a thick line to be drawn and at least one of a start point and an end point of a line path corresponding to the thick line;
determining a plurality of polygon vertexes according to the predetermined pattern; and
performing a polygon filling operation to fill a polygon region defined by the polygon vertexes, and storing a drawing result of filling the polygon region into a frame buffer.

2. The thick line drawing method of claim 1, further comprising:
determining a line segment along a line path corresponding to a dotted thick line; and
utilizing two ends of the line segment to set the start point and the end point of the thick line to be drawn.

3. The thick line drawing method of claim 1, wherein the step of drawing at least a predetermined pattern comprises:
performing a circle drawing operation to draw at least a first circle according to a first point serving as a center point and a first radius determined according to the thickness of the thick line, where the thick line has the first point and a second point, one of the first point and the second point is the start point, and the other of the first point and the second point is the end point.

4. The thick line drawing method of claim 3, wherein the thickness of the thick line is equal to an even number; the step of performing the circle drawing operation comprises:
setting a first integer equal to a half of the even number to be the first radius of the first circle;
setting a second integer equal to a half of the even number minus one to be a second radius of a second circle; and
performing the circle drawing operation to determine the first circle and the second circle according to the first radius, the second radius, and at least one of the first point and the second point serving as center point(s); and
the step of determining the polygon vertexes comprises:
determining the polygon vertexes according to a circumference of the first circle and a circumference of the second circle.

5. The thick line drawing method of claim 4, wherein the step of determining the polygon vertexes according to the circumference of the first circle and the circumference of the second circle comprises:
determining a first quantized normal vector defined by a center point of the first circle and a point at the circumference of the first circle according to a reference vector defined by the start point and the end point;
determining a second quantized normal vector defined by a center point of the second circle and a point at the circumference of the second circle according to the reference vector defined by the start point and the end point; and
determining the polygon vertexes according to the first quantized normal vector, the second quantized normal vector, the first point, and the second point.

6. The thick line drawing method of claim 5, wherein the step of determining the polygon vertexes according to the first quantized normal vector and the second quantized normal further comprises:
when a first error index value indicating a thickness error cause by the first quantized normal vector is not less than a first threshold value, adjusting the first quantized normal vector to thereby reduce the thickness error; and
when a second error index value indicating a thickness error caused by the second quantized normal vector is not less than a second threshold value, adjusting the second quantized normal vector to thereby reduce the thickness error.

7. The thick line drawing method of claim 3, wherein the step of determining the polygon vertexes comprises:
determining a quantized normal vector defined by the first point and a point at a circumference of the first circle according to a reference vector defined by the start point and the end point; and
determining the polygon vertexes according to the quantized normal vector, the first point, and the second point.

8. The thick line drawing method of claim 7, wherein the step of determining the polygon vertexes according to the quantized normal vector, the first point, and the second point further comprises:
when an error index value indicating a thickness error caused by the quantized normal vector is not less than a threshold value, adjusting the quantized normal vector to thereby reduce the thickness error.

9. The thick line drawing method of claim 1, wherein the step of drawing at least a predetermined pattern comprises:
performing a regular polygon drawing operation to draw a regular polygon according to a first point serving as a center point and a radius determined according to the thickness of the thick line, wherein the thick line has the first point and a second point, one of the first point and the second point is the start point of the thick line, and the other of the first point and the second point is the end point of the thick line;

10. The thick line drawing method of claim 9, wherein the step of determining the polygon vertexes comprises:
determining the polygon vertexes according to sides of the regular polygon.

11. A thick line drawing apparatus, comprising:
a frame buffer;
a pattern drawing engine, for drawing at least a predetermined pattern according to a thickness of a thick line to be drawn and at least one of a start point and an end point of a line path corresponding to the thick line; and
a polygon filling engine, coupled to the pattern drawing engine and the frame buffer, for determining a plurality of polygon vertexes according to the predetermined pattern, performing a polygon filling operation to fill a polygon region defined by the polygon vertexes, and storing a drawing result of the polygon region into the frame buffer.

12. The thick line drawing apparatus of claim 11, further comprising:
a line drawing engine, coupled to the pattern drawing engine, for determining a line segment along a line path corresponding to a dotted thick line and setting the start point and the end point of the thick line by two ends of the line segment.

13. The thick line drawing apparatus of claim 11, wherein the pattern drawing engine is a circle drawing engine configured to perform a circle drawing operation to draw at least a first circle according to a first point serving as a center point and a first radius determined according to the thickness of the thick line, where the thick line has the first point and a second point, one of the first point and the second point is the start point, and the other of the first point and the second point is the end point.

14. The thick line drawing apparatus of claim 13, wherein the thickness of the thick line is equal to an even number; the circle drawing engine sets a first integer equal to a half of the even number to be the first radius of the first circle, sets a second integer equal to a half of the even number minus one to be a second radius of a second circle, and performs the circle drawing operation to determine the first circle and the second circle according to the first radius, the second radius, and at least one of the first point and the second point serving as center point(s); and the polygon filling engine determines the polygon vertexes according to a circumference of the first circle and a circumference of the second circle.

15. The thick line drawing apparatus of claim 14, wherein the polygon filling engine determines a first quantized normal vector defined by a center point of the first circle and a point at the circumference of the first circle according to a reference vector defined by the start point and the end point, determines a second quantized normal vector defined by a center point of the second circle and a point at the circumference of the second circle according to the reference vector defined by the start point and the end point, and determines the polygon vertexes according to the first quantized normal vector and the second quantized normal vector.

16. The thick line drawing apparatus of claim 15, wherein when a first error index value indicating a thickness error cause by the first quantized normal vector is not less than a first threshold value, the polygon filling engine adjusts the first quantized normal vector to thereby reduce the thickness error; and when a second error index value indicating a thickness error caused by the second quantized normal vector is not less than a second threshold value, the polygon filling engine adjusts the second quantized normal vector to thereby reduce the thickness error.

17. The thick line drawing apparatus of claim 13, wherein the polygon filling engine determines a quantized normal vector defined by the first point and a point at a circumference of the first circle according to a reference vector defined by the start point and the end point, and determines the polygon vertexes according to the quantized normal vector, the first point, and the second point.

18. The thick line drawing apparatus of claim 17, wherein when an error index value indicating a thickness error caused by the quantized normal vector is not less than a threshold value, the polygon filling engine further adjusts the quantized normal vector to thereby reduce the thickness error.

19. The thick line drawing apparatus of claim 11, wherein the pattern drawing engine is a regular polygon drawing engine configured to perform a regular polygon drawing operation to draw at least a regular polygon according to a first point serving as a center point and a radius determined according to a thickness of a thick line to be drawn, wherein the thick line has the first point and a second point, one of the first point and the second point is the start point, and the other of the first point and the second point is the end point.

20. The thick line drawing apparatus of claim 19, wherein the polygon filling engine determines the polygon vertexes according to sides of the regular polygon.
